(19) United States
(12) Patent Application Publication
(10) Pub. No.: US 2020/0408318 A1
(43) Pub. Date: Dec. 31, 2020

(54) ELECTROMAGNETIC VALVE

(71) Applicant: NIDEC TOSOK CORPORATION, Kanagawa (JP)

(72) Inventors: Dongming CHEN, Kanagawa (JP); Tomohiko NAKANISHI, Kanagawa (JP)

(73) Assignee: NIDEC TOSOK CORPORATION, Kanagawa (JP)

(21) Appl. No.: 16/874,638

(22) Filed: May 14, 2020

(30) Foreign Application Priority Data
Jun. 28, 2019 (JP) 2019-120686

(51) Int. Cl. F16K 31/06; F16K 27/04

(52) U.S. Cl. CPC F16K 31/061; F16K 27/048

(57) ABSTRACT

An electromagnetic valve includes: a solenoid, including a bobbin, a plunger, and a coil that moves the plunger; and a valve mechanism, including a flow path member that includes a first flow path, a second flow path, a relay flow path and a valve body housing, and a valve body that is inserted into the valve body housing, movably supported along an axial direction together with the plunger, and switches between passage and blockage of a fluid via the relay flow path between the first flow path and the second flow path. The valve body includes a protrusion provided protruding radially outward from an outer periphery of the valve body and guided by an inner wall surface of the valve body housing when the valve body moves.

### CROSS REFERENCE TO RELATED APPLICATIONS

The present invention claims priority under 35 U.S.C. § 119 to Japanese Application No. 2019-120686 filed on Jun. 28, 2019, the entire content of which is incorporated herein by reference.

### FIELD OF THE INVENTION

The disclosure relates to an electromagnetic valve.

### BACKGROUND

Conventionally, there has been known an electromagnetic valve that switches between passage and blockage of gas. The above electromagnetic valve includes a fixed core, a movable core capable of approaching the fixed core under the action of an electromagnetic force, and a gas flow path formation member including a gas introduction hole and a gas discharge hole. A tubular part guiding the movable core is fixed to the fixed core. A valve body is attached to an end of the movable core opposite the fixed core. As the movable core moves, the valve body opens the gas introduction hole and allows gas to pass from the gas introduction hole to the gas discharge hole; conversely, the valve body is able to close the gas introduction hole and stop the passage of the gas.

In the above electromagnetic valve, the entire outer periphery of the movable core is in contact with an inner periphery of the tubular part, and the contact area increases as much as the amount of the contact. As a result of the increased contact area, there is a problem that the sliding resistance at the time the movable core moves increases and slidability of the movable core deteriorates. In addition, when impurities enter between the outer periphery of the movable core and the inner periphery of the tubular part, the sliding resistance further increases, and the movement of the movable core is further hindered, that is, the slidability of the movable core further deteriorates.

### SUMMARY

An exemplary embodiment of the present disclosure provides an electromagnetic valve, including a solenoid and a valve mechanism. The solenoid includes a bobbin of a tubular shape including a through hole penetrating along an axial direction, a plunger inserted into the through hole and movably supported along the axial direction, and a coil wound around an outer periphery of the bobbin, generating a magnetic force by being energized and moving the plunger. The valve mechanism includes a flow path member connected to the solenoid and a valve body of a columnar shape. The flow path member includes a first flow path, a second flow path, a relay flow path connecting the first flow path and the second flow path, and a valve body housing disposed adjacent to the relay flow path and along the axial direction. The valve body is inserted into the valve body housing, movably supported along the axial direction together with the plunger, and switches between passage and blockage of a fluid via the relay flow path between the first flow path and the second flow path. The valve body includes a protrusion provided protruding radially outward from an outer periphery of the valve body and guided by an inner wall surface of the valve body housing when the valve body moves.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a longitudinal sectional view showing a first exemplary embodiment of an electromagnetic valve of the present disclosure.

FIG. 2 is a perspective view of a valve body provided in the electromagnetic valve shown in FIG. 1.

FIG. 3 is a view (side view) as viewed from the direction of arrow A in FIG. 2.

FIG. 4 is a view (front view) as viewed from the direction of arrow B in FIG. 2.

FIG. 5 is a perspective view of a valve body provided in an electromagnetic valve (second exemplary embodiment) of the present disclosure.

FIG. 6 is a front view of a valve body provided in an electromagnetic valve (third exemplary embodiment) of the present disclosure.

### DETAILED DESCRIPTION

Hereinafter, an electromagnetic valve of the present disclosure will be described in detail based on exemplary embodiments shown in the accompanying drawings.

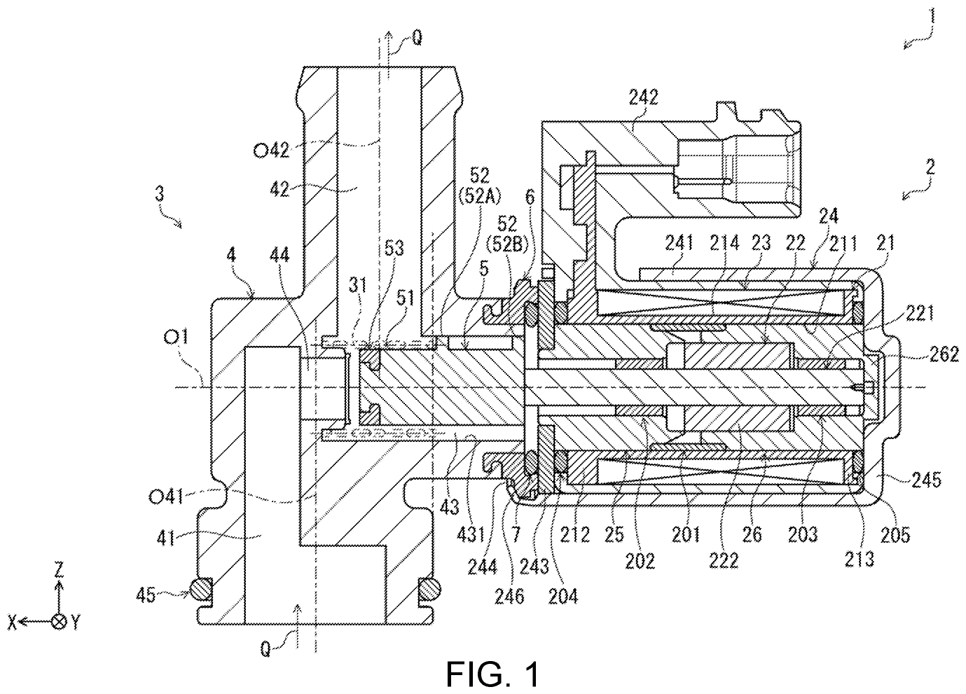

A first exemplary embodiment of an electromagnetic valve of the present disclosure will be described with reference to FIG. 1 to FIG. 4. In the following, for convenience of description, three axes orthogonal to each other are set as an X axis, a Y axis, and a Z axis. As an example, an XY plane including the X axis and the Y axis is horizontal, and the Z axis is vertical. A direction parallel to the X axis may be referred to as “axial direction (axis O1 direction),” a radial direction about this axis may be simply referred to as “radial direction,” and a circumferential direction about the aforesaid axis may be simply referred to as “circumferential direction.” A positive side in the X axis direction may be referred to as “one end side in the axial direction” or simply “one end side,” and a negative side in the X axis direction may be referred to as “the other end side in the axial direction” or simply “the other end side.” In this specification, vertical direction, horizontal direction, upper side and lower side are simply names for describing relative positional relationships between each part, and the actual arrangement relationships may be arrangement relationships other than those indicated by these names.

An electromagnetic valve 1 shown in FIG. 1 is, for example, mounted on an internal combustion engine such as a gasoline engine or the like for use. Examples of exhaust gas emitted from the internal combustion engine include the exhaust gas generated by combustion of fuel in the internal combustion engine, blow-by gas leaking from a piston seal of the internal combustion engine, fuel vapor gas in which fuel in a fuel tank is vaporized, and so on. In the present exemplary embodiment, the electromagnetic valve 1 is used as a switching valve that switches between passage and blockage of blow-by gas.

As shown in FIG. 1, the electromagnetic valve 1 includes a solenoid 2 disposed on the negative side in the X axis direction and a valve mechanism 3 disposed on the positive side in the X axis direction. Hereinafter, configurations of each part will be described. The solenoid 2 includes a bobbin 21, a plunger 22, a coil 23, a case 24, a core 25, and a yoke 26.

The bobbin 21 is a tubular or substantially tubular member including a through hole 211. The through hole 211 penetrates along the axis O1 direction parallel to the X axis direction. An inner diameter of the through hole 211 is constant along the axis O1 direction. The bobbin 21 includes a flange 212 protruding in the radial direction on one end side, and a flange 213 protruding in the radial direction on the other end side. The bobbin 21 is made of, for example, various thermosetting resins such as a polyester resin or a polyimide resin or the like.

A coil 23 having conductivity is wound around an outer periphery 214 of the bobbin 21. By energizing the coil 23, a magnetic circuit is defined by the bobbin 21, the core 25 and the yoke 26, and a magnetic force is able to be generated. Accordingly, the plunger 22 is able to be reciprocated along the axis O1 direction.

The core 25 and the yoke 26 are inserted into the through hole 211 of the bobbin 21, and the plunger 22 is inserted further inside.

The core 25 is disposed on one end side in the axis O1 direction, and the yoke 26 is disposed on the other end side in the axis O1 direction.

The core 25 has a circular cylindrical or substantially circular cylindrical shape as a whole, and is disposed parallel to the X axis direction. The yoke 26 also has a circular cylindrical or substantially circular cylindrical shape as a whole, and is disposed parallel to the X axis direction. The core 25 and the yoke 26 include a magnetic material such as iron or the like, that is, they are made of a magnetic metal material. Accordingly, a magnetic circuit is able to be generated that is able to sufficiently reciprocate the plunger 22.

In addition, the solenoid 2 includes in the through hole 211 a connecting member 201 connecting the core 25 and the yoke 26 while keeping the core 25 and the yoke 26 apart. The connecting member 201 has a circular cylindrical or substantially circular cylindrical shape, inside which the other end of the core 25 and one end of the yoke 26 are fitted. The connecting member 201 is made of a nonmagnetic and rust-resistant metal material such as austenitic stainless steel or the like.

The plunger 22 is disposed across the core 25 and the yoke 26 and is supported to be movable alternately between the one end side and a base end side along the axis O1 direction, that is, the plunger 22 is reciprocatably supported. The plunger 22 includes a plunger body 222 of a circular cylindrical or substantially circular cylindrical shape, and a plunger pin 221 inserted into the plunger body 222. The plunger pin 221 protrudes on both of the one side and the other side in the axis O1 direction. In addition, the other end side of the yoke 26 is closed by a wall part 262. By contact (that is, collision) of the plunger pin 221 with the wall part 262, a movement limit of the plunger 22 to the other end side is controlled.

In addition, in the plunger 22, the plunger pin 221 is supported by a bush 202 in the core 25, and the plunger pin 221 is supported by a bush 203 in the yoke 26. Accordingly, the plunger 22 is able to smoothly reciprocate.

The case 24 houses the bobbin 21, the plunger 22, the coil 23, the core 25, and the yoke 26. The case 24 includes a case body 241, a connector member 242, and a ring member 243.

The case body 241 has a tubular or substantially tubular shape with a bottom. That is, the case body 241 is a tubular or substantially tubular member including an opening 244 open on the one side in the axis O1 direction and a wall part 245 closing the other side. The yoke 26 contacts the wall part 245 from the one end side.

The ring member 243 has an annular or substantially annular shape and is disposed radially outside and concentrically with the core 25. The ring member 243 contacts the core 25 from the one end side.

Like the core 25, the case body 241 and the ring member 243 are made of a magnetic metal material such as iron or the like.

The connector member 242 is connected to a connector (not shown) that energizes the coil 23. Like the bobbin 21, the connector member 242 is made of, for example, a thermosetting resin.

In addition, the solenoid 2 includes in the case 24 a gasket 204 disposed between the ring member 243 and the flange 212 of the bobbin 21, and a gasket 205 disposed between the wall part 245 of the case body 241 and the flange 213 of the bobbin 21.

The gasket 204 has a ring shape or substantially ring shape and is disposed on the outer peripheral side of and concentrically with the core 25. The gasket 204 is in a compressed state between the ring member 243 and the flange 212 of the bobbin 21, and accordingly, a gap between the ring member 243 and the flange 212 is able to be sealed.

The gasket 205 has a ring shape or substantially ring shape and is disposed radially outside and concentrically with the yoke 26. The gasket 205 is in a compressed state between the wall part 245 of the case body 241 and the flange 213 of the bobbin 21, and accordingly, a gap between the wall part 245 and the flange 213 is able to be sealed.

Moreover, the gasket 204 and the gasket 205 are made of an elastic material having elasticity. The elastic material is not particularly limited, and examples thereof include various rubber materials such as urethane rubber, silicone rubber and so on.

The valve mechanism 3 includes a flow path member 4, a valve body 5, a connecting member 6, and a gasket 7.

The flow path member 4 is a member connected to the solenoid 2 via the connecting member 6, and is configured to allow a fluid Q to pass therethrough. As described above, in the present exemplary embodiment, the electromagnetic valve 1 is used as a switching valve that switches between passage and blockage of blow-by gas. Therefore, the fluid Q serves as the blow-by gas.

The flow path member 4 includes therein a first flow path 41, a second flow path 42, a relay flow path 44, and a valve body housing 43.

The first flow path 41 is provided along the Z axis direction and opens toward the negative side in the Z axis direction. In addition, the first flow path 41 side is connected to, for example, a fixing structure (not shown) to which the electromagnetic valve 1 is fixed, and is in a state of being opened to the atmosphere. In addition, a gasket 45 sealing a gap between the flow path member 4 and the fixing structure is fitted to the flow path member 4 from the outside.

The second flow path 42 is also provided along the Z axis direction and opens toward the positive side in the Z axis direction. Moreover, a central axis O42 of the second flow path 42 is located on the negative side in the X axis direction with respect to a central axis O41 of the first flow path 41. In addition, the second flow path 42 is connected to, for example, a flexible tube.

The relay flow path 44 is provided along the X axis direction, that is, the axis O1 direction, and connects the first flow path 41 and the second flow path 42. For example, in the case where the internal combustion engine equipped with the electromagnetic valve 1 is a naturally aspirated engine, as shown in FIG. 1, the fluid Q flows from the first flow path 41 to the second flow path 42 via the relay flow path 44. In addition, in the case where the internal combustion engine equipped with the electromagnetic valve 1 is a turbo engine, when boost pressure acts, the fluid Q flows from the second flow path 42 to the first flow path 41 via the relay flow path 44.

The valve body housing 43 movably housing the valve body 5 is disposed adjacent to the relay flow path 44 on the negative side in the X axis direction. The valve body housing 43 is provided along the X axis direction (axis O1 direction) and opens toward the negative side in the X axis direction. A sectional shape (that is, cross-sectional shape) of the valve body housing 43 in a direction orthogonal to the X axis direction of the valve body housing 43 is circular or substantially circular, and an inner diameter of the valve body housing 43 is constant along the X axis direction. In addition, the inner diameter of the valve body housing 43 is larger than an inner diameter of the relay flow path 44.

Moreover, like the bobbin 21, the flow path member 4 is made of, for example, a thermosetting resin.

In addition, the valve mechanism 3 includes a coil spring 31 housed in the valve body housing 43 together with the valve body 5. The coil spring 31 is provided on the positive side in the X axis direction, that is, the one side in the axis O1 direction, with respect to the valve body 5. In addition, the coil spring 31 is in a compressed state between a wall surface of the valve body housing 43 on the positive side in the X axis direction and the valve body 5. Accordingly, a pushing force pushing the valve body 5 toward the negative side in the X axis direction, that is, the other side in the axis O1 direction, is able to be applied to the valve body 5. Due to this pushing force, the valve body 5 is able to be separated from the relay flow path 44, and therefore, the relay flow path 44 is able to be opened. Moreover, it is possible to close the relay flow path 44 by the following way: when the plunger 22 moves toward the positive side in the X axis direction against the pushing force of the coil spring 31, the valve body 5 approaches the relay flow path 44, and blocks the relay flow path 44.

The connecting member 6 has a ring shape or substantially ring shape and is fixed to the flow path member 4 radially outside the valve body housing 43. A bent part 246 defined by bending the opening 244 side of the case 24 radially inward is hooked to the connecting member 6, that is, the opening 244 side of the case 24 is crimped. By the crimping, the connecting member 6 is connected to the case 24, and therefore, a positional relationship between the valve mechanism 3 and the solenoid 2 is controlled. Accordingly, power from the solenoid 2, that is, force of the plunger 22, is able to be transmitted to the valve body 5 of the valve mechanism 3, and therefore, the valve body 5 is able to be moved. Like the connecting member 201, the connecting member 6 is made of, for example, a nonmagnetic and rust-resistant metal material.

The gasket 7 is disposed between the connecting member 6 and the ring member 243. The gasket 7 has a ring shape or substantially ring shape and is provided concentrically with the valve body housing 43. The gasket 7 is in a compressed state between the connecting member 6 and the ring member 243, and accordingly, a gap between the connecting member 6 and the ring member 243 is able to be sealed. Moreover, like the gasket 204, the gasket 7 is made of an elastic material having elasticity.

The valve body 5 having a columnar or substantially columnar shape is inserted into the valve body housing 43 of the flow path member 4. The valve body 5 is movably supported along the axis O1 direction together with the plunger 22. By movement of the valve body 5, the relay flow path 44 is able to be opened and closed as described above. Accordingly, between the first flow path 41 and the second flow path 42, the passage and blockage of the fluid Q via the relay flow path 44 and the valve body housing 43 is able to be switched. Moreover, the valve body 5 may include various metal materials such as aluminum or the like.

In addition, a gasket 53 having a ring shape or substantially ring shape is mounted on the valve body 5 on the positive side in the X axis direction. When the valve body 5 closes the relay flow path 44, the gasket 53 is able to be in close contact with the valve body 5 along the shape of an edge of the relay flow path 44. Accordingly, the relay flow path 44 is sufficiently closed, and therefore, the fluid Q is more reliably blocked. Moreover, like the gasket 204, the gasket 53 is made of an elastic material having elasticity.

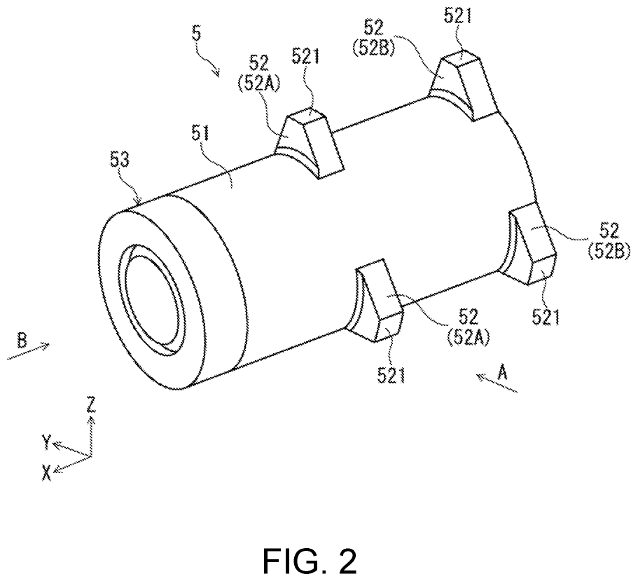

As shown in FIG. 2, the valve body 5 includes a plurality of protrusions 52. The plurality of protrusions 52 are each provided protruding radially outward from an outer periphery 51 of the valve body 5.

In addition, among the plurality of protrusions 52, the protrusion 52 located on the positive side in the X axis direction is referred to as “first protrusion 52A,” and the protrusion 52 located on the negative side in the X axis direction is referred to as “second protrusion 52B.” Three first protrusions 52A are provided at equal intervals along the circumferential direction of the valve body 5, and three second protrusions 52B are also provided at equal intervals along the circumferential direction of the valve body 5. There are respectively three first protrusions 52A and three second protrusions 52B provided along the circumferential direction of the valve body 5. However, the disclosure is not limited thereto, and there may be four or more first protrusions 52A and four or more second protrusions 52B provided along the circumferential direction of the valve body 5. In addition, the number of the first protrusions 52A disposed is the same as the number of the second protrusions 52B disposed. However, the disclosure is not limited thereto, and the number of the first protrusions 52A disposed may be different from and the number of the second protrusions 52B disposed.

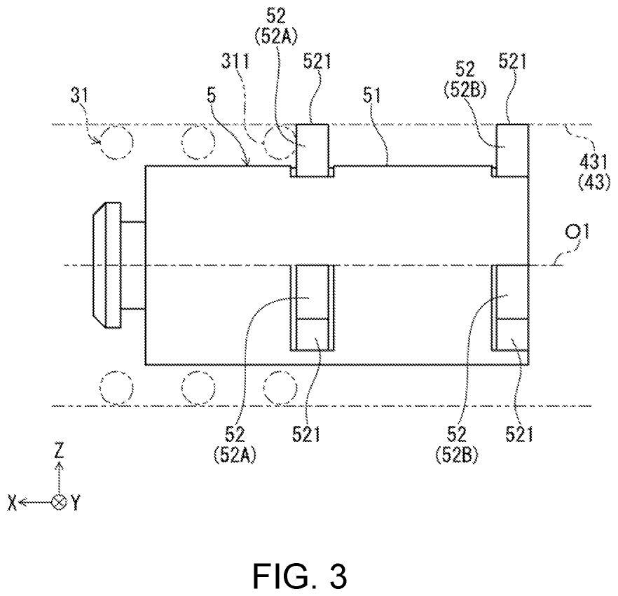

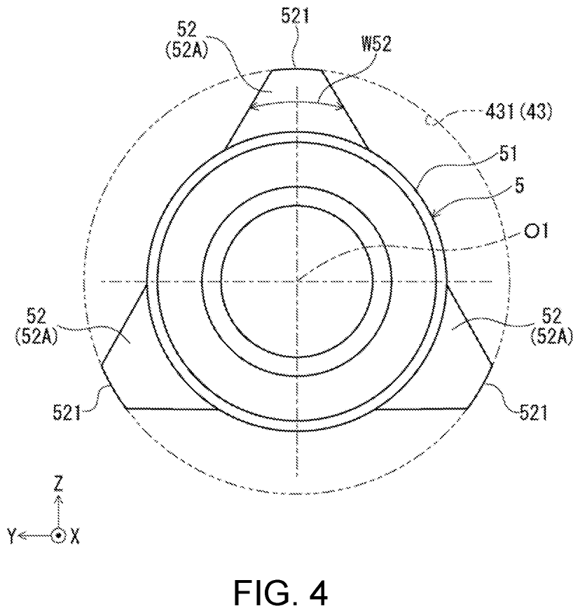

As shown in FIG. 3 and FIG. 4, a top portion 521 located radially outermost in each protrusion 52 contacts and is guided by an inner wall surface 431 of the valve body housing 43 when the valve body 5 moves. Accordingly, sliding area (contact area) of the valve body 5 with the inner wall surface 431 is able to be reduced as much as possible, and accordingly, sliding resistance is able to be reduced as much as possible. As a result, it is possible for the valve body 5 to stably slide, that is, slidability of the valve body 5 is improved. In addition, even if the fluid Q contains an impurity, due to the small area of the top portion 521 of each protrusion 52, attachment of the impurity to the top portion 521 is able to be suppressed or prevented. Accordingly, it is possible to prevent the movement of the valve body 5 from being hindered by impurities, and therefore, the slidability of the valve body 5 is further improved.

As shown in FIG. 3, each first protrusion 52A functions as a spring seat contacted by an end 311 on the negative side in the X axis direction (the other side in the axis O1 direction) of the coil spring 31. Accordingly, separate provision of the spring seat is able to be omitted, and therefore, the electromagnetic valve 1 is able to have a simple configuration.

As described above, there are respectively three first protrusions 52A and three second protrusions 52B provided at equal intervals along the circumferential direction of the valve body 5. In addition, the first protrusions 52A and the second protrusions 52B are provided apart from each other in the X axis direction (axis O1 direction). Accordingly, a posture of the valve body 5 in the valve body housing 43 is able to be maintained, and therefore, the valve body 5 is able to stably move in the valve body housing 43.

As shown in FIG. 4, a width W52 of each protrusion 52 along the circumferential direction of the valve body 5 gently decreases (that is, gradually decreases) radially outward. Accordingly, sliding area of each protrusion 52 with respect to the inner wall surface 431 of the valve body housing 43 is able to be reduced as much as possible while strength of each protrusion 52 during movement of the valve body 5 is maintained. In addition, in the top portion 521 of each protrusion 52, the sliding area also increases with wear over time due to sliding. When the sliding area increases, since the pressure acting on the top portion 521 also increases, it is conceivable that a wear speed at the top portion 521 becomes constant at a predetermined timing.

In addition, as described above, the cross-sectional shape of the valve body housing 43 is circular or substantially circular. The top portion 521 of each protrusion 52 has an arc or substantially arc shape having the same curvature as the circular or substantially circular shape of the valve body housing 43. Accordingly, it is possible for the valve body 5 to smoothly slide.

In addition, when negative pressure acts on the second flow path 42 side when the relay flow path 44 is in the opened state, the fluid Q is able to pass between adjacent protrusions 52. Accordingly, the pressures on the positive side and negative side in the X axis direction with respect to the valve body 5 are canceled out by each other, and therefore, unwanted movement of the valve body 5 is able to be prevented. The term “negative pressure” herein refers to a state in which the pressure on the second flow path 42 side is lower than the pressure on the first flow path 41 side.

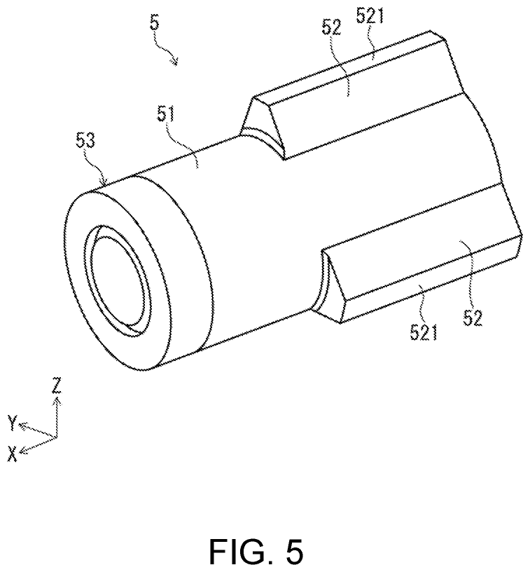

Hereinafter, a second exemplary embodiment of the electromagnetic valve of the present disclosure will be described with reference to FIG. 5. However, the description will focus on differences from the above-described exemplary embodiment, and the description of the same matters will be omitted.

The present exemplary embodiment is the same as the first exemplary embodiment except that the protrusion of the valve body has a different shape.

As shown in FIG. 5, in the present exemplary embodiment, each protrusion 52 is a ridge along the X axis direction (axis O1 direction). Accordingly, the posture of the valve body 5 in the valve body housing 43 is able to be maintained, and therefore, the valve body 5 is able to stably move in the valve body housing 43. An entire length of each protrusion 52 is calculated from the middle of the valve body 5 in the X axis direction to an end surface of the valve body 5 on the negative side in the X axis direction, but is not limited thereto. The entire length of each protrusion 52 is the same, but is not limited thereto, and may be different.

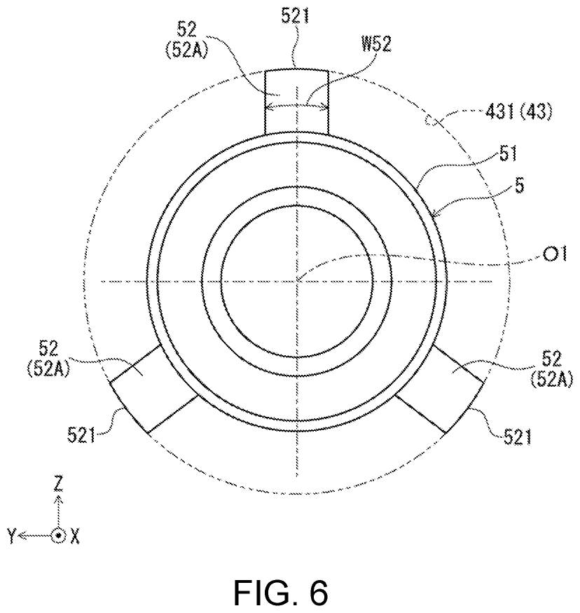

Hereinafter, a third exemplary embodiment of the electromagnetic valve of the present disclosure will be described with reference to FIG. 6. However, the description will focus on differences from the above-described exemplary embodiments, and the description of the same matters will be omitted.

The present exemplary embodiment is the same as the first exemplary embodiment except that the protrusion of the valve body has a different shape.

As shown in FIG. 6, in the present exemplary embodiment, the width W52 of each protrusion 52 is constant along the radial direction. Accordingly, even if the protrusion 52 wears due to sliding, the sliding area of the protrusion 52 with respect to the inner wall surface 431 of the valve body housing 43 is able to be made constant, and therefore, the slidability of the valve body 5 is able to be stably maintained constant.

Although the electromagnetic valve of the present disclosure has been described above with the exemplary embodiments shown in the drawings, the disclosure is not limited thereto. Each of the parts that define the electromagnetic valve may be replaced with any configuration able to exhibit the same function. In addition, any component may be added.

In addition, the electromagnetic valve of the present disclosure may be a combination of any two or more configurations (features) in the above exemplary embodiments.

In addition, in the above exemplary embodiments, the electromagnetic valve is mounted on an internal combustion engine such as a gasoline engine or the like for use. However, the electromagnetic valve is applicable to not only internal combustion engines. In addition, the fluid whose passage and blockage is switched by the electromagnetic valve is not limited to a gas and may be a liquid or a mixture of a gas and a liquid.

The shape of the protrusion included in the valve body may be a ring shape or substantially ring shape along the circumferential direction of the valve body.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. An electromagnetic valve comprising:
a solenoid comprising:
a bobbin of a tubular shape comprising a through hole penetrating along an axial direction;
a plunger inserted into the through hole and movably supported along the axial direction; and
a coil wound around an outer periphery of the bobbin, generating a magnetic force by being energized and moving the plunger; and
a valve mechanism comprising:
a flow path member connected to the solenoid and comprising:
a first flow path;
a second flow path;
a relay flow path connecting the first flow path and the second flow path; and
a valve body housing disposed adjacent to the relay flow path and along the axial direction; and
a valve body of a columnar shape, inserted into the valve body housing, movably supported along the axial direction together with the plunger, and switching between passage and blockage of a fluid via the relay flow path between the first flow path and the second flow path, wherein
the valve body comprises a protrusion provided protruding radially outward from an outer periphery of the valve body and guided by an inner wall surface of the valve body housing when the valve body moves.

2. The electromagnetic valve according to claim 1, wherein three or more of the protrusions are provided along a circumferential direction of the valve body.

3. The electromagnetic valve according to claim 1, wherein a width of the protrusion along a circumferential direction of the valve body decreases radially outward.

4. The electromagnetic valve according to claim 2, wherein a width of the protrusion along the circumferential direction of the valve body decreases radially outward.

5. The electromagnetic valve according to claim 1, wherein a width of the protrusion along a circumferential direction of the valve body is constant along a radial direction.

6. The electromagnetic valve according to claim 2, wherein a width of the protrusion along the circumferential direction of the valve body is constant along a radial direction.

7. The electromagnetic valve according to claim 1, wherein the protrusion is a ridge along the axial direction.

8. The electromagnetic valve according to claim 5, wherein the protrusion is a ridge along the axial direction.

9. The electromagnetic valve according to claim 1, wherein a plurality of the protrusions are provided apart from each other in the axial direction.

10. The electromagnetic valve according to claim 5, wherein a plurality of the protrusions are provided apart from each other in the axial direction.

11. The electromagnetic valve according to claim 1, wherein
a sectional shape of the valve body housing in a direction orthogonal to the axial direction is a circle, and
a top portion located radially outermost in the protrusion has an arc shape having the same curvature as the circle.

12. The electromagnetic valve according to claim 9, wherein
a sectional shape of the valve body housing in a direction orthogonal to the axial direction is a circle, and
a top portion located radially outermost in the protrusion has an arc shape having the same curvature as the circle.

13. The electromagnetic valve according to claim 1, wherein
the valve mechanism comprises a coil spring provided on one side in the axial direction with respect to the valve body and pushing the valve body toward the other side in the axial direction, and
the protrusion functions as a spring seat contacted by an end of the coil spring on the other side in the axial direction.

14. The electromagnetic valve according to claim 2, wherein
the valve mechanism comprises a coil spring provided on one side in the axial direction with respect to the valve body and pushing the valve body toward the other side in the axial direction, and
the protrusion functions as a spring seat contacted by an end of the coil spring on the other side in the axial direction.

15. The electromagnetic valve according to claim 3, wherein
the valve mechanism comprises a coil spring provided on one side in the axial direction with respect to the valve body and pushing the valve body toward the other side in the axial direction, and
the protrusion functions as a spring seat contacted by an end of the coil spring on the other side in the axial direction.

16. The electromagnetic valve according to claim 5, wherein
the valve mechanism comprises a coil spring provided on one side in the axial direction with respect to the valve body and pushing the valve body toward the other side in the axial direction, and
the protrusion functions as a spring seat contacted by an end of the coil spring on the other side in the axial direction.

17. The electromagnetic valve according to claim 7, wherein
the valve mechanism comprises a coil spring provided on one side in the axial direction with respect to the valve body and pushing the valve body toward the other side in the axial direction, and
the protrusion functions as a spring seat contacted by an end of the coil spring on the other side in the axial direction.

18. The electromagnetic valve according to claim 9, wherein
the valve mechanism comprises a coil spring provided on one side in the axial direction with respect to the valve body and pushing the valve body toward the other side in the axial direction, and
the protrusion functions as a spring seat contacted by an end of the coil spring on the other side in the axial direction.

19. The electromagnetic valve according to claim 11, wherein
the valve mechanism comprises a coil spring provided on one side in the axial direction with respect to the valve body and pushing the valve body toward the other side in the axial direction, and
the protrusion functions as a spring seat contacted by an end of the coil spring on the other side in the axial direction.
